(19) United States
(12) Patent Application Publication
(10) Pub. No.: US 2025/0280232 A1
(43) Pub. Date: Sep. 4, 2025

(54) METHODS AND SYSTEMS FOR SOUND COLLECTION

(71) Applicant: Adeia Guides Inc., San Jose, CA (US)

(72) Inventors: Serhad Doken, Bryn Mawr, PA (US); Zhiyun Li, Kenmore, WA (US)

(21) Appl. No.: 19/047,830

(22) Filed: Feb. 7, 2025

Related U.S. Application Data
(60) Provisional application No. 63/558,936, filed on Feb. 28, 2024.

(51) Int. Cl. H04R 3/00; H04R 29/00

(52) U.S. Cl. CPC H04R 3/005; H04R 29/005

(57) ABSTRACT

Systems and methods are described for providing an audio signal generated by a first node determined to have the current optimal audio output to other nodes associated with a sound collection session. A sound collection session for a plurality of nodes is initiated. A target sound source for the sound collection session is determined. The node of a plurality of nodes associated with the sound collection session currently able to generate an optimal audio output corresponding to the target sound source is dynamically determined.

### CROSS-REFERENCE TO RELATED APPLICATION

This application claims the benefit of U.S. Patent Application No. 63/558,936, filed Feb. 28, 2024, the entire contents of which are hereby incorporated by reference herein.

### BACKGROUND

The present disclosure relates to methods and systems for sound collection and distribution. Particularly, but not exclusively, the present disclosure relates to sound collection and distribution for a group of nodes.

### SUMMARY

Current audio technology enables a user device such as a smartphone to capture sound and then provide that sound to a further device, such as a pair of earphones connected to the user device and being utilized to provide audio output. Such technology is applicable to various scenarios, whereby positioning the user device close to the sound source, the user may receive clearer audio of that particular sound source. For example, this technology is beneficial when a user wishes to receive clearer audio of, for example, a person, when they are in a crowded or noisy venue, where positioning the user device closer to the person may enable the sound captured by the user device to be naturally amplified with respect to other sounds in the venue.

A limitation of this technology is that it is assumed that the sound source is static. If the sound source moves (e.g., away from the user device), the user device will be unlikely to capture audio of sufficient quality. Furthermore, sounds in an environment are captured indiscriminately, e.g., without focus on a sound in which the user may be interested (e.g., a particular person speaking). Thus, sound that the user is uninterested in is amplified along with sound from the desired sound source, reducing the clarity of the sound from the desired sound source.

Systems and methods are provided herein for improving the quality of a listening experience, reducing latency, and reducing operational demands on servers. In particular, systems and methods herein may enable a group of listeners to receive improved audio of a particular sound source. For example, by dynamically determining which node of a plurality of nodes associated with a sound collection session is able to generate an optimal audio output corresponding to the target sound source, and providing an audio signal generated by that node to other nodes associated with the sound collection sessions, nodes (e.g., user devices and so on) may be provided with the best available audio of a target sound source, thereby enabling a listener to have an improved quality of listening experience, even when the target sound source is moving. In some examples, the determination of the node which is able to generate the optimal audio output may indicate, or be used to determine, the location of a sound. In the context of the present disclosure, the term “optimal audio output” is understood to be an audio output satisfying one or more criteria. For example, the optimal audio output may be an audio output having one or more characteristics from a set of predefined characteristics, such as timbre, transparency, stereophonic imaging, spatial presentation, reverberance, echoes, harmonic distortions, quantization noise, pops, clicks and/or background noise. The optimal audio output may be the audio output which best satisfies the one or more criteria, e.g., by falling within or closest to a set value (e.g., a threshold value) range of one or more of the predefined characteristics. In some examples, the optimal audio output may be an audio output having one or more characteristics closest matching one or more of a user's preferred characteristics, e.g., based on a setting in a user profile. In some examples, the optimal audio output may be specific to the type of target sound source. For example, the characteristics of an optimal audio output when the target sound source is a person's voice may be different from the characteristics of an optimal audio output when the target sound source is an instrument or machinery. In some examples, an optimal audio output may be determined using a standardized algorithm, such as the perceptual evaluation of audio quality (PEAQ) algorithm.

According to the systems and methods described herein, a sound collection session is initiated for a plurality of nodes. For example, a sound collection session may be initiated at least in part by initiating a mesh network, such as a Bluetooth mesh network or a WiFi mesh network, a 5G side link connection, or any short range Device-to-Device network. A sound collection session may initiate the generation of a mesh network. The plurality of nodes may be, for example, user devices, and may be connected to the mesh network. A target sound source for the sound collection session may be determined. For example, a target sound source may be isolated, or separated, from other sounds which are also present. The target sound source may be indicated based on a signal received from a user device, such as an indication of a user to select a particular target sound source. A node of a plurality of nodes associated with the sound collection session which is currently able to generate an optimal audio output corresponding to the target sound source may be determined, e.g., dynamically determined. For example, where the target sound source is a moving sound source, it may be beneficial to dynamically (e.g., periodically or continuously) monitor which node of the plurality of nodes is able to generate an optimal audio output corresponding to the target sound source, as the node able to generate the optimal audio output may change as the target sound source moves. The optimal audio output may be audio output of a particular node which is assessed to have the highest quality of audio output among audio outputs of the plurality of nodes. The optimal audio output may be determined to be from a node which is closest to the target sound source. An audio signal (e.g., corresponding to the target sound source) generated by a first node determined to currently have the optimal audio output is provided to other nodes associated with the sound collection session. For example, an audio stream generated by the optimal node may be sent to other nodes of the sound collection session (e.g., connected to the mesh network). A sound collection session may be, for example, a group listen session, in which nodes associated with the sound collection session cause the received audio signal to be output, such that a user can hear the audio. The audio signal may comprise audio of the target sound source which has been isolated from other sounds.

In some examples, it may be determined whether the quality of the audio signal has fallen below a predefined threshold. For example, where the target sound source has moved away from the node currently providing the audio signal, the quality of the audio signal may be reduced. The node which is currently able to generate the optimal audio output of the target sound source may be redetermined when the quality of the provided audio signal falls below the predefined threshold. For example, a reduction in the quality of the provided audio signal may trigger a reassessment of which node is able to generate an optimal audio signal. An audio signal generated by a second node determined to have the current optimal audio output may be provided to other nodes associated with the sound collection session. For example, the audio signal of the newly determined node may be provided to other nodes rather than the audio signal of the previous optimal node.

In some examples, the redetermining further comprises determining the identity of nodes within a predefined distance of the node currently determined to be able to generate the optimal audio output. For example, the distance of nodes which are part of the mesh network from the node currently determined to be able to generate the optimal audio output may be determined, where nodes within e.g., a particular radius, of the node may be determined. The predetermined distance may be variable. For example, where no other nodes are determined to be within a particular distance of the node, the distance may be increased (e.g., incrementally). The redetermining may further comprise determining which node of the nodes within the predefined distance is currently able to generate the optimal audio output of the target sound source. For example, each node determined to be within the predefined distance may be assessed to determine which node is able to generate the optimal audio output. These steps may be repeated (e.g., iteratively) until the node currently determined to currently be able to generate the optimal audio output has the optimal audio output of nodes within the predefined distance of that node. For example, where the currently selected node has the optimal audio output of nodes within the predefined distance, it may be determined that that node should be used to generate the audio signal.

In some examples, an audio signature of the target sound source is generated. An audio signature may be a set of unique characteristics corresponding to the target sound source, such as a particular pitch, tone, frequency, cadence, or audio/speech pattern (e.g., word or phrase selection). For example, an audio fingerprint may be generated. The audio signature may be distributed to nodes associated with the sound collection session. The audio signature may be usable to identify the target sound source. The audio output of each node may be assessed based on the audio signature. For example, the audio signature may be comparable to the audio output of a node in order to determine the quality of the audio output of that node.

In some examples, a mesh network for the plurality of nodes is initiated (e.g., in response to the initiation of the sound collection session). The mesh network may utilize protocols and/or standards for short-distance wireless communication between nodes (e.g., wherein the nodes utilize transmission power enabling a wireless range of 10 feet, 30 feet, 100 feet, 500 feet, etc.). The mesh network may be a Bluetooth mesh network, and/or a WiFi mesh network. In some examples, the mesh network is dynamic. For example, the mesh network may be updated to remove nodes and/or to include nodes in the network. For example, nodes may be added or removed from the network as they become available or unavailable (e.g., move into or out of a range of the network), and/or in response to nodes opting to join or leave the network. In some examples, the target sound source may move relative to the mesh network (e.g., relative to the topology of the mesh network). For example, the target sound source may be a moving sound source, where the mesh network may be substantially stationary (e.g., nodes of the mesh network may be stationary). In other examples, the mesh network may move relative to the target sound source (e.g., nodes of the mesh network may move, and the target sound source may be substantially stationary), and/or both the target sound source and the mesh network (e.g., nodes connected to the mesh network) may move.

In some examples, which node of the plurality of nodes associated with the sound collection session is currently able to generate the optimal audio output of the target sound source is assessed, e.g., reassessed periodically. For example, the nodes may be assessed at regular and/or irregular time intervals which may be beneficial in the event that the target sound source moves. In some examples, assessing which node of the plurality of nodes associated with the sound collection session is currently able to generate the optimal audio output of the target sound source may be determined based on a trigger event, such as a change in a characteristic of the target sound source being detected, e.g., based on a determined or predicted movement of the target sound source. In some examples, movement of the target sound source may be determined based on a signal generated by a user device associated with and/or producing the target sounds source.

In some examples, which of the plurality of nodes associated with the sound collection session is currently able to generate an optimal audio output of the target sound source is determined in response to receiving a user request. For example, a user request may be received to reassess which node is currently able to generate the optimal audio output (for example, where the user considers that the quality of the audio signal has been reduced).

In some examples, dynamically determining which node of a plurality of nodes associated with the sound collection session is currently able to generate an optimal audio output of the target sound source comprises dynamically determining which node of the plurality of nodes associated with the sound collection session is currently closest to the target sound source, and determining the node closest to the target sound source as being able to generate an optimal audio output of the target sound source. For example, using localization techniques, the location of each node in the mesh network may be determined, and the location of the target sound source may be determined, using localization techniques, where it may then be assumed that the node with a location which is closest to the location of the target sound source is able to generate the optimal audio output. In some examples, a mesh network may know or be able to determine the topology of the nodes in the network, but not know the position of each node relative to their environment. As such, one or more references from the environment may be determined. For example, there may be one or more other sensors and/or systems configured to help determine the locations of nodes, the sound source in the environment and one of more objects in the environment, for example, a GPS system, an indoor positioning system (IPS), a WiFi indoor localization system, Bluetooth low energy (BLE) beacons, imaging devices, etc. Such sensors and/or systems may be used in cooperation with or instead of a determined mesh topology.

In some examples, a plurality of target sound sources is determined for the sound collection session. For example, where a conversation is occurring between two people, it may be determined that two target sound sources are present. An audio signature may be generated for each target sound source. For each target sound source, it may be dynamically determined which node of the plurality of nodes associated with the sound collection session is currently able to generate an optimal audio output corresponding to that target sound source based on the audio signature. For example, each target sound source may be best served by different nodes, or by the same node. A plurality of audio signals each corresponding to a different target sound source and generated by the node determined to currently be able to generate an optimal audio output corresponding to that target sound source may be provided to other nodes associated with the sound collection session. For example, the optimal node for each target sound source may be used to produce audio signals of their respective target sound source, where both signals are then sent to other nodes associated with the sound collection session. The audio signal corresponding to a target sound source may comprise audio corresponding to the audio signature for that target sound source. For example, the audio signal may be processed to isolate the audio corresponding to the target sound source, so that each generated audio signal only comprises audio of their respective target sound source.

In some examples, the optimal audio output of the target sound source may be determined based on a quality of the audio output of a plurality of nodes. For example, the quality of the audio output may be based on a MOS (mean opinion score) or a MDAQS (multi-dimensional audio quality score), which may be computed for the audio output of each of a plurality of nodes. These computed scores may be compared to a threshold (e.g., MOS>3), or historical scores for a particular target sound source, to determine the quality of the audio output. In some examples, a trained machine learning model may be utilized to output a score of quality, for example, for particular types of sound sources.

In some examples, the optimal audio output of the target sound source may be determined based on a distance of each node of the plurality of nodes associated with the sound collection session from the target sound source. For example, it may be determined that a node closest to the target sound source is able to generate the optimal audio output of the target sound source. However, in some examples, the closest node may have a lower audio quality than a node further away, e.g., depending on microphone orientation, occlusion, etc. As such, a node that is not the closest node to the sound source may have the optimal audio output of the target sound source, e.g., as a result of the topology of the mesh network, one or more characteristics of the environment (such as a location of a wall), and/or an operational capability of a component associated with the node (such as a quality of a microphone receiving the sound).

In some examples, the audio output of the target sound source generated by a node is assessed at the node at which it is generated. For example, based on a received audio signature or fingerprint, a node may determine a score for its own audio output. The determination of which of the plurality of nodes is currently able to generate an optimal audio output of the target sound source may then be made based on an indication of the assessment received from the node. For example, the score determined by the node may be sent to, for example, the cloud or a further node, where this score may then be compared to scores of other nodes to determine which node has the optimal audio output.

In some examples, it is determined whether the target sound source has changed. For example, during a conversation between individuals, the individual who is speaking may change. In response to determining that the target sound source has changed, it may be determined which node of a plurality of nodes associated with the sound collection session is able to generate an optimal audio output corresponding to the target sound source. For example, the node which is able to generate the optimal audio output for the new target sound source may be different to the node which was able to generate an optimal audio output for the previous target sound source. An audio signal corresponding to the changed target sound source generated by the node determined to have the optimal audio output (for the changed target sound source) may be provided to other nodes associated with the sound collection session.

According to the systems and methods described herein, a sound collection session is initiated for a plurality of nodes. A target sound source for the sound collection session is determined. A node of a plurality of nodes associated with the sound collection session which is currently able to generate an optimal audio output corresponding to the target sound source is dynamically determined. The location of the target sound source is determined based on at least one of the location of the node which is currently able to generate an optimal audio output corresponding to the target sound source, or an audio signal generated by the node which is currently able to generate an optimal audio output corresponding to the target sound source.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 illustrates an overview of a system for determining a node currently able to generate an optimal audio output of a target sound source and providing an audio signal from that node, in accordance with some examples of the disclosure;

FIG. 2 is a block diagram showing components of an example system for providing an audio signal generated by a node determined to have the current optimal audio output to other nodes, in accordance with some examples of the disclosure;

FIG. 3 is a flowchart representing a process for providing an audio signal generated by a node determined to have the current optimal audio output to other nodes, in accordance with some examples of the disclosure;

FIG. 4 illustrates an example of an interface of a node acting as a host node, in accordance with some examples of the disclosure;

FIG. 5 illustrates an example of an interface of a node acting as a host node, in accordance with some examples of the disclosure;

FIG. 6 is a flowchart representing a process for dynamically determining which node is currently able to generate an optimal audio output corresponding to the target sound source, in accordance with some examples of the disclosure;

FIG. 7a-f illustrates an example of a system for determining a node currently able to generate an optimal audio output of a target sound source, in accordance with some examples of the disclosure;

FIG. 8 illustrates an example of a system for determining the nodes currently able to generate optimal audio outputs for a plurality of a target sound sources, in accordance with some examples of the disclosure;

FIG. 9 is a flowchart representing a process for dynamically determining which nodes are currently able to generate an optimal audio output corresponding to a plurality of target sound sources, in accordance with some examples of the disclosure;

FIG. 10a-b illustrates an example of a system for determining the node currently able to generate an optimal audio output when a target sound source changes, in accordance with some examples of the disclosure;

FIG. 11 is a flowchart representing an illustrative process for dynamically determining which node is able to generate an optimal audio output when a target sound source changes, in accordance with some examples of the disclosure; and

FIG. 12 is a flowchart representing an illustrative process for determining which node to utilize to provide an audio signal corresponding to a target sound source, in accordance with some examples of the disclosure.

### DETAILED DESCRIPTION

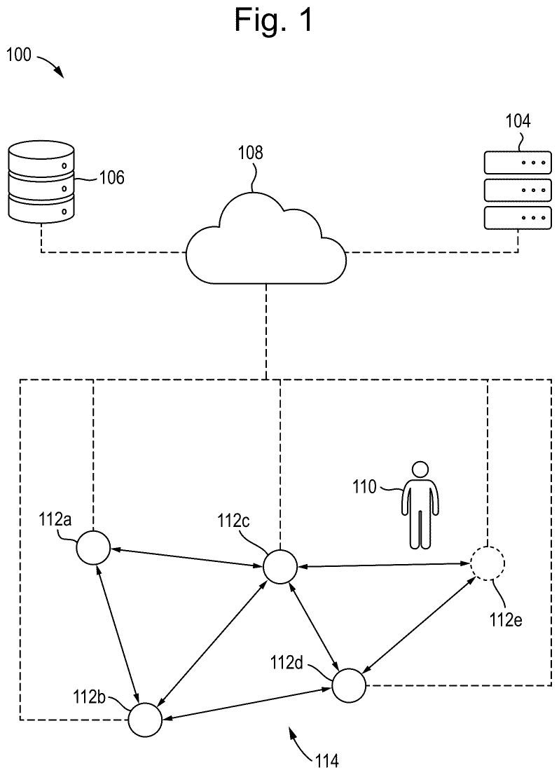

FIG. 1 illustrates an overview of a system 100 for determining a node currently able to generate an optimal audio output of a target sound source 110 and providing an audio signal from that node. In particular, the example shown in FIG. 1 illustrates a plurality of nodes 112a-e which are connected or communicatively coupled to one another via a network 114, where the connection between the nodes is illustrated by arrows in this Figure. The network 114 established between the nodes may be any appropriate type of network, such as a Bluetooth mesh network, a WiFi mesh network, a 5G side link connection, or any short range Device-to-Device network. In this example, each node 112 (the nodes illustrated in FIG. 1 are labelled 112a-112e, the reference numeral 112 is used here to refer to any of nodes 112a-112e) is additionally communicatively coupled to a server 104 and a content item database 106, e.g., via a cloud network 108. In this manner, the server 104 may operate to control functionality associated by the nodes 112, such as determining which node is to provide audio output to the other nodes.

Each node 112 may be an electronic device such as a user device. Example devices include wearable devices (e.g., smart watches), mobile phones, tablets, computers such as laptop computers or desktop computers, terminal devices, and so on. Any device with the capability to connect to other nodes via a short range Device-to Device network may be a network node. Each node may comprise at least one microphone capable of capturing sound.

While in this example, each node 112 is illustrated as being coupled to the cloud network 108, in some examples, only one node 112, for example, a node which is acting as a host node (in this example, node 112a may be assumed to be the host node) and instructing and/or relaying information to other nodes 112, may be connected to the cloud network 108. In other examples, there may be no connection of nodes 112 to the cloud network for the purposes of the methods described herein, where a host node 112a may instead perform the functions that will be described below in relation to elements of the cloud network 108.

Thus, in some examples, the computations carried out by the (cloud) server 104 as described herein may be performed by any node associated with the sound collection session. A benefit of the functions being performed locally by a node of the system is that, since the performance of methods described herein may be latency sensitive, a communication delay with the server 104, for example, may cause issues with latency. By performing the computation at one of the local nodes, this issue may be solved. A further benefit of this example is that it only requires local or short-range communication, and it does not need backhaul or Internet connections.

In some examples, a node 112 comprises control circuitry configured to enable sound collection from a microphone of the node. In some examples, control circuitry of the node 112 is further configured to assess the quality of audio output generated by that node. In some examples, control circuitry of the node 112 is configured to assess the quality of audio output generated by a plurality of nodes, and determine which of the plurality of nodes is currently able to generate an optimal audio output corresponding to the target sound source. In other examples, the server 104 may instead comprise control circuitry which is configured to determine which node of the plurality of nodes is currently able to generate an audio output corresponding to the target sound source, such as by receiving audio output generated by the nodes, and assessing the quality of the received audio output. In other examples, each node may assess the quality of their own audio output, and send an indicator of the quality of their audio output to the server 104, where the server 104 may then compare the assessments to determine which node is currently able to produce the optimal audio output.

In this example, a first node 112e (e.g., an optimal node) is determined to have the current optimal audio output. The way in which it is determined which node has the current optimal audio output will be described in more detail below. The first node 112e generates an audio signal which is then distributed to other nodes in the network 114. For example, the audio signal may be distributed through the Bluetooth mesh network 114, or may be distributed via the cloud network 108, and/or may be distributed via the host node 112a. The node acting as the host node 112a may be changed at any time, for example, upon request from another node of the network. In some examples, once a node has been determined to be the node currently able to provide the optimal audio output, that node may become the host node.

The examples as described herein may apply to any scenario in which it is desirable to obtain an optimal audio signal of a target sound source. For example, in a lecture theatre, by determining which node of a network is able to provide an optimal sound output of a target sound source, and distributing an audio signal to other nodes in the theatre, each user may be able to experience an improved listening experience due to the increase in quality of audio of a target sound source that they are able to experience. This may equally be the case is other scenarios such as classrooms, meetings, theatres (while watching a performance), live performances, concerts, during presentations, or any scenario in which some nodes may be able to obtain better audio (e.g. by proximity to the target sound source) than other nodes. Other scenarios to which the method may be applicable include home monitoring (e.g., child or baby monitoring) or surveillance, any crowded setting, such as weddings, parties, restaurants, meeting rooms, large residences, robots operating in a factory setting, vehicles (such as vehicles in an urban congested area, e.g., a busy intersection), wireless sensor network devices which are equipped with microphones, and so on. The methods may also be applicable in scenarios in which particular important sounds that may require user action may occur, such as announcements made over a speaker system, alerts, alarms, and warnings.

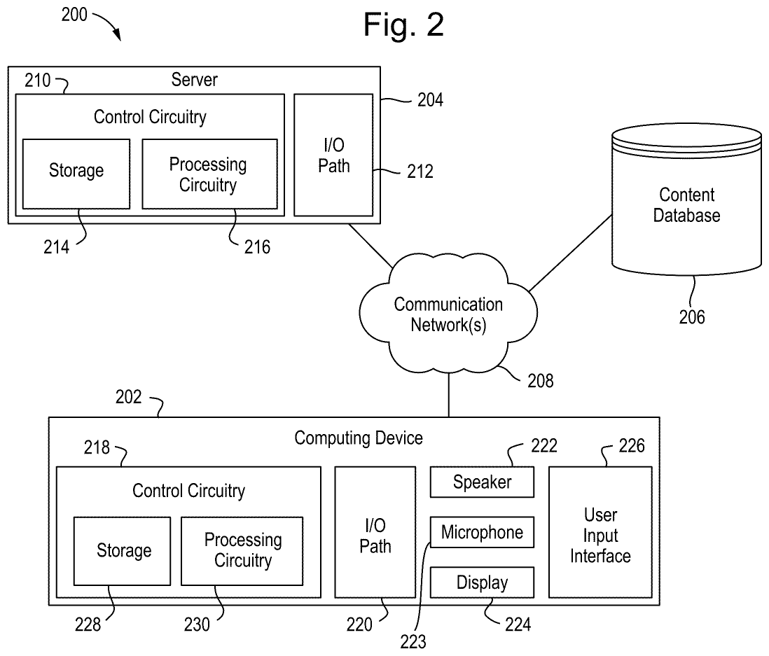

FIG. 2 is an illustrative block diagram showing example system 200, e.g., a non-transitory computer-readable medium, configured to provide an audio signal generated by a first node (e.g., first node 112e) determined to have the current optimal audio output to other nodes. Although FIG. 2 shows system 200 as including a number and configuration of individual components, in some examples, any number of the components of system 200 may be combined and/or integrated as one device. System 200 includes computing device n-202 (denoting any appropriate number of computing devices, such as nodes 112a-112e), server n-204 (denoting any appropriate number of servers, such as server 104), and one or more content databases n-206 (denoting any appropriate number of content databases, such as content database 106), each of which is communicatively coupled to communication network 208, which may be the Internet or any other suitable network or group of networks, such as network 108. In some examples, system 200 excludes server n-204, and functionality that would otherwise be implemented by server n-204 is instead implemented by other components of system 200, such as computing device n-202. For example, computing device n-202 may implement some or all of the functionality of server n-204, allowing computing device n-202 to communicate directly with content database n-206. In still other examples, server n-204 works in conjunction with computing device n-202 to implement certain functionality described herein in a distributed or cooperative manner.

Server n-204 includes control circuitry 210 and input/output (hereinafter “I/O”) path 212, and control circuitry 210 includes storage 214 and processing circuitry 216. Computing device n-202, which may be an HMD, a personal computer, a laptop computer, a tablet computer, a smartphone, a smart television, smart watch, earbud, or any other type of computing device, includes control circuitry 218, I/O path 220, speaker 222, microphone 223, display 224, and user input interface 226. Control circuitry 218 includes storage 228 and processing circuitry 220. Control circuitry 210 and/or 218 may be based on any suitable processing circuitry such as processing circuitry 216 and/or 230. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some examples, processing circuitry may be distributed across multiple separate processors, for example, multiple of the same type of processors (e.g., two Intel Core i9 processors) or multiple different processors (e.g., an Intel Core i7 processor and an Intel Core i9 processor).

Each of storage 214, 228, and/or storages of other components of system 200 (e.g., storages of content database 206, and/or the like) may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 2D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 214, 228, and/or storages of other components of system 200 may be used to store various types of content, metadata, and or other types of data. Non-volatile memory may also be used (e.g., to launch a boot-up routine and other instructions). Cloud-based storage may be used to supplement storages 214, 228 or instead of storages 214, 228. In some examples, control circuitry 210 and/or 218 executes instructions for an application stored in memory (e.g., storage 214 and/or 228). Specifically, control circuitry 210 and/or 218 may be instructed by the application to perform the functions discussed herein. In some implementations, any action performed by control circuitry 210 and/or 218 may be based on instructions received from the application. For example, the application may be implemented as software or a set of executable instructions that may be stored in storage 214 and/or 228 and executed by control circuitry 210 and/or 218. In some examples, the application may be a client/server application where only a client application resides on computing device n-202, and a server application resides on server n-204.

The application may be implemented using any suitable architecture. For example, it may be a stand-alone application wholly implemented on computing device n-202. In such an approach, instructions for the application are stored locally (e.g., in storage 228), and data for use by the application is downloaded on a periodic basis (e.g., from an out-of-band feed, from an Internet resource, or using another suitable approach). Control circuitry 218 may retrieve instructions for the application from storage 228 and process the instructions to perform the functionality described herein. Based on the processed instructions, control circuitry 218 may determine what action to perform when input is received from user input interface 226.

In client/server-based examples, control circuitry 218 may include communication circuitry suitable for communicating with an application server (e.g., server n-204) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the Internet or any other suitable communication networks or paths (e.g., communication network 208). In another example of a client/server-based application, control circuitry 218 runs a web browser that interprets web pages provided by a remote server (e.g., server n-204). For example, the remote server may store the instructions for the application in a storage device. The remote server may process the stored instructions using circuitry (e.g., control circuitry 210) and/or generate displays. Computing device n-202 may receive the displays generated by the remote server and may display the content of the displays locally via display 224. This way, the processing of the instructions is performed remotely (e.g., by server n-204) while the resulting displays, such as the display windows described elsewhere herein, are provided locally on computing device n-202. Computing device n-202 may receive inputs from the user via input interface 226 and transmit those inputs to the remote server for processing and generating the corresponding displays.

A computing device n-202 may send instructions, e.g., to initiate a sound collection session or send an audio signal, to control circuitry 210 and/or 218 using user input interface 226.

User input interface 226 may be any suitable user interface, such as a remote control, trackball, keypad, keyboard, touchscreen, touchpad, stylus input, joystick, voice recognition interface, gaming controller, or other user input interfaces. User input interface 226 may be integrated with or combined with display 224, which may be a monitor, a television, a liquid crystal display (LCD), an electronic ink display, or any other equipment suitable for displaying visual images.

Server n-204 and computing device n-202 may transmit and receive content and data via I/O path 212 and 220, respectively. For instance, I/O path 212, and/or I/O path 220 may include a communication port(s) configured to transmit and/or receive (for instance to and/or from content database n-206), via communication network 208, content item identifiers, content metadata, natural language queries, and/or other data. Control circuitry 210 and/or 218 may be used to send and receive commands, requests, and other suitable data using I/O paths 212 and/or 220.

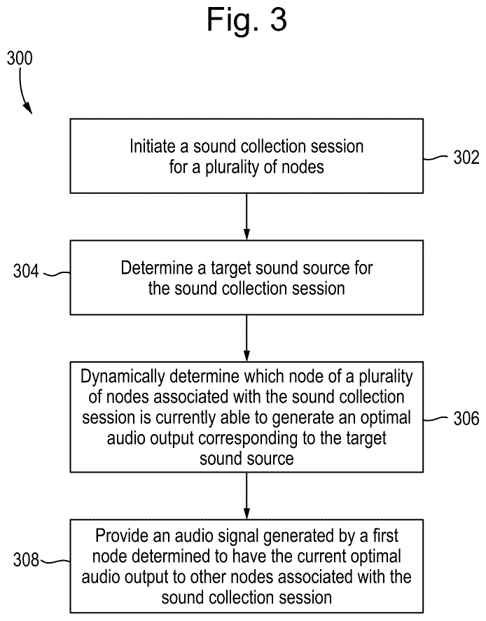

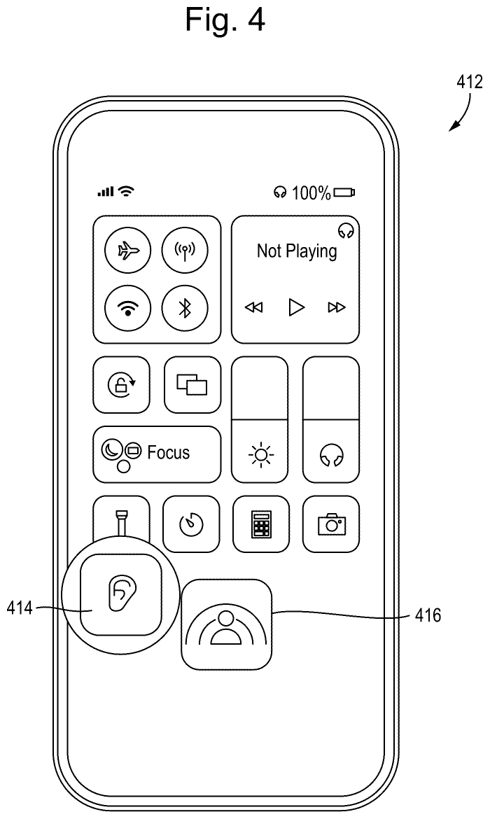

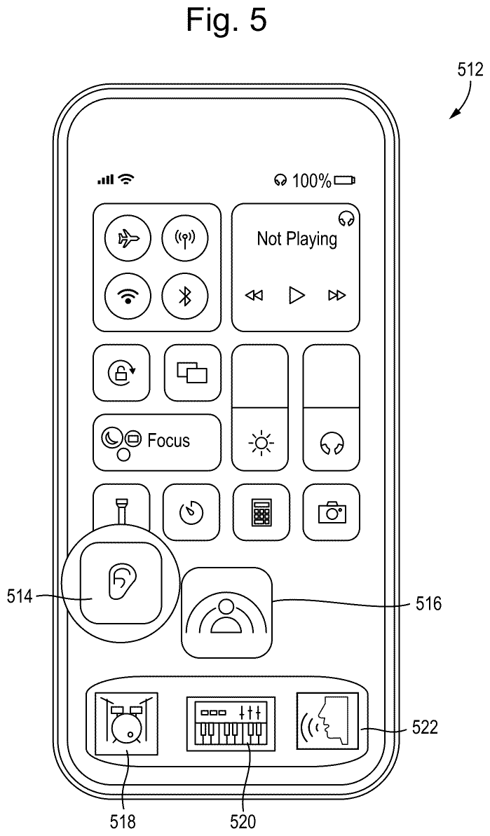

FIG. 3 shows a flowchart representing an illustrative process 300 for providing an audio signal generated by a first node determined to have the current optimal audio output to other nodes, such as the nodes 112 shown in FIG. 1. FIG. 4 illustrates an example interface of a host device. FIG. 5 illustrates an example interface of a host device. While the example shown in FIG. 3 refers to the use of system 100, as shown in FIG. 1, it will be appreciated that the illustrative process 300 shown in FIG. 3, with reference to FIGS. 4 and 5, may be implemented, in whole or in part, on system 100, system 200, and/or any other appropriately configured system architecture. For the avoidance of doubt, the term “control circuitry” used in the below description applies broadly to the control circuitry outlined above with reference to FIG. 2. For example, control circuitry may comprise control circuitry of a node 112 or control circuitry of the server 104, working either alone or in some combination.

At 302, control circuitry, e.g., control circuitry of a node 112 or control circuitry of the server 104, initiates a sound collection session for a plurality of nodes. A sound collection session may be a period of time in which a node is configured to capture current audio relating to a target sound source, where this audio may then be distributed to other nodes 112. The other nodes 112 may be nodes 112 which are connected via the sound collection session. For example, a sound collection session may be initiated by an application on a device such as a smartphone. A particular node, such as node 112a of FIG. 1, may be used to initiate the sound collection session, for example, by selecting an icon representing a sound collection session, and may thus act as a host node. A name may be assigned to the sound collection session (e.g., a description of the sound collection session) by the host node, which may enable users of other nodes to identify a sound collection session.

FIG. 4 illustrates an example of the interface of a node 412 (in this example, a user device—a smartphone) acting as the host node. In this example, a sound collection icon is shown, where a user may select the sound collection icon 414 in order to initiate a sound collection session. This example further illustrates a pictorial representation of the sound collection session in the form of a sound collection session icon 416, which may be generated once the sound collection icon 414 is selected.

The initiation of the sound collection session may also initiate the collection of sound data by the host node 112a for a predefined period of time in order to establish at least one type of sound which is present in the environment of the host node 112a. For example, a sound type may be music, speech, random audio, and so on. Any appropriate method may be used in order to determine the sound type, where, for example, for complex and/or noisy environments, machine learning models may be used to perform the classification. In some examples, a speech-to-text (STT) algorithm may be used in parallel with the use of a machine learning model in order to accelerate the classification, as an STT process may quickly determine if a particular sound is speech.

Where the environment in which the host node 112a is currently situated has multiple sound sources, or is a multi-sound environment, sound separation may be performed to isolate different sounds. Any appropriate sound isolation method may be performed in order to separate sounds in the environment.

At 304, control circuitry, e.g., control circuitry of a node 112 or control circuitry of the server 104, determines a target sound source for the sound collection session. The target sound source may be determined by receiving an indication from a node, such as node 112a of FIG. 1 through which the sound collection has been initiated, as to a particular sound source that should be the target sound source. The node 112a may first process audio received at the node 112a, separating different sound sources in the audio as described above, and then output an indication of the different sound sources such that a user may select a target sound source from the various sound sources. For example, where there are multiple persons speaking within audible range of the node 112a, the sound produced from each person may be isolated from the other sounds, whereby the user may then select one of these persons as a target sound source. The isolated sound sources may be presented to a user visually, for example, using different visual representations to represent each sound source. Additionally or alternatively, a sound sample of each isolated sound source may be playable such that the user is able to identify which of the sound sources they wish to set as the target sound source 110. Once the target sound source 110 has been determined, the target sound source 110 may be set for the sound collection session. The target sound source may remain the same until the sound collection session ends (e.g., is ended by the host node 112a).

FIG. 5 illustrates an example of a node 512 (in this example, a user device—a smartphone) acting as the host node. As is described in relation to FIG. 4, a user has selected a sound collection icon 514 to initiate a sound collection session, where the sound collection session is illustrated by a sound collection session icon 516. As is further illustrated in this example, the node outputs pictorial representations of sound sources which have been detected and isolated. For example, an icon representing a drum set 518, an icon representing a keyboard 520, and an icon representing speech 522 are shown as different potential target sound sources. An icon may be selected (e.g., by a user) in order to determine the target sound source 110 for the sound collection session. A preview in the form of a sound clip may be playable for each icon to enable the user to further identify the particular sound sources (for example, where there is more than one speaker).

The initiation of the sound collection session may initiate the establishing of a mesh network 114 (e.g., a device to device network), for example, by sending a notification or the like to other nodes in close proximity regarding the sound collection session, other nodes may opt to join the network. These nodes 112 may be in the vicinity of one another, e.g., within the same venue or location. Thus, the initiating of the sound collection session may comprise initiating a mesh network for a plurality of nodes within a particular distance of one another. The limiting distance between nodes of the mesh network may be based on a range of the particular network connecting the nodes, for example, based on the limitation of a Wi-Fi range, or Bluetooth range. The mesh network may utilize protocols or standards for short-distance wireless communication between nodes (e.g., wherein the nodes utilize transmission power enabling a wireless range of 10feet, 30 feet, 100 feet, 500 feet, etc.). The host node may initiate a Bluetooth Mesh network, which may be based on the Bluetooth Low Energy standard. The Bluetooth Mesh network may be enabled or supported by a third party solution at a node where the node does not natively support a Bluetooth Mesh network. In some examples, the initiating of the mesh network 114 may occur after the target sound source 110 has been determined. In other examples, the mesh network 114 may be established prior to the target sound source 110 being determined.

Additional nodes (e.g., user devices) may join the network. Once devices have joined the network, the new devices may become nodes in the mesh network. A larger number of nodes in the mesh network may enable a larger area to be covered by the network. For example, a maximum number of nodes in a Bluetooth Mesh network is approximately 32,000. Assuming a spacing between the nodes of 10 meters, approximately 320,000 square meters may be covered by the network. The scalability of the network enables use of the methods described herein in a variety of scenarios.

Nodes of the mesh network (e.g., a Bluetooth mesh network) may communicate using a publish/subscribe paradigm. Any node may broadcast a message to the whole network by publishing to a specific “topic”. Subsequently, any node which subscribes to this “topic” will receive the message. The Bluetooth Low Energy standard is designed to broadcast very small amounts of data (31 bytes), and a Bluetooth Mesh network has limitations on the payload (up to 29 bytes other than the network overhead). As such, transmission of data between nodes 112 in the mesh 114 may be adapted or controlled accordingly. In some examples, when the payload is not sufficient for audio streaming, the payload may simply be used to manage the sound collection session, e.g., by transmitting one or more control signals between one or more nodes 112 in the mesh 114.

In some examples, where a potential node 112 has their short-range radio activated (e.g., Bluetooth radio), and is in proximity to the host node 112a, the potential node may be able to view (e.g., receive directly or indirectly from the host node) information on active sound collection sessions (e.g., view icons associated with particular sound collection session, listen to a sound clip of the target sound source, and so on) via the mesh network 114. These other nodes 112 may opt to join a sound collection session via the mesh network 114 based on the information on active sound collection sessions. In some examples, information such as a sound clip and an indication of the target sound source (e.g., an icon metatag) may be transmitted to the server 104 via the cloud network 108 to be broadcast and advertised to other potential nodes of the sound collection session. For example, once a node is part of the mesh network, a duplex (WebSocket) port to the Cloud API may be opened in order to download the information. Nodes which receive the transmission may opt to join the sound collection session.

Once a node 112 joins the sound collection session, the node 112 may be assigned with a unique identifier (ID). In an example, to reduce the usage of the payload space, a 2-byte unsigned integer (which can support approximately 64,000 devices) may be used, rather than a full 16-byte Universal Unique Identifier (UUID), for example. A maximum number of nodes may be set for the sound collection session (e.g., a maximum size of 64 devices may be set for the session).

The server 104 may receive from the host node 112a a sound source audio buffer (e.g., captured sound of the target sound source). The server 104 may analyze the sound source audio buffer and generate an audio signature (e.g., an audio fingerprint) of the target sound source 110. An audio signature may be a set of unique characteristics corresponding to the target sound source, such as a particular pitch, tone, frequency, cadence, or speech pattern (e.g., word or phrase selection). The audio signature may be sent to the nodes associated with the sound collection session such that each node is able to identify the target sound source 110 for audio collection of the target sound source 110. In some examples, the generation of the audio signature may instead be performed by the host node. The audio signature may be sent to the server 104, or may be directly or indirectly sent from the host node 112a to other nodes 112 of the network 114, e.g., via the network 114.

The audio signature may be generated by analyzing qualities of the sound source audio buffer, such as any or any combination of discriminative power, distortion invariance, compactness, computational simplicity, and so on. The audio signature may be a set of unique characteristics corresponding to the target sound source, such as a particular pitch, tone, frequency, cadence, or audio/speech pattern (e.g., word or phrase selection). A real-time dataset may be built from the sound source audio buffer and used for training a machine learning model used to generate the audio signature, which may enable the audio signature to be generated faster. To perform audio fingerprinting for the target sound source, any or any combination of methods such as frame splitting, windowing, STFT (Short-Time Fourier Transform), and band splitting across the spectrogram may be performed on the sound source audio buffer. The audio fingerprint (audio signature) may comprise a short form of coded representation of the audio that uniquely identifies the target source. Any appropriate method which is capable of generating an identifier which is able to uniquely identify a particular sound may be used to generate the audio fingerprint. The resultant audio fingerprint may be transmitted to nodes associated with the sound collection session.

At 306, control circuitry, e.g., control circuitry of a node 112 or control circuitry of the server 104, dynamically determines which node of a plurality of nodes associated with the sound collection session is currently able to generate an optimal audio output corresponding to the target sound source. For example, the host node 112a may determine which node of the nodes which are part of the sound collection session (e.g., connected via the network 114) is currently able to generate the best audio output of the target sound source.

As is described above, the host node 112a may send, directly or indirectly, to the other nodes associated with the sound collection session an audio signature of the target sound source, such that the nodes are able to identify sound generated from the target sound source 110. For example, the host node 112a may send the audio signature via the network 114, or the cloud network 108 may distribute the audio signature once received from the host node 112a (e.g., a cloud application programming interface (API) may be invoked, and the audio signature downloaded at a node). Each node 112 associated with the sound collection session may collect current audio of their surroundings, for example, using a microphone or array of microphones. In some examples, the microphone is a microphone integrated into the device which acts as the node. In some examples, the microphone may be a microphone of a secondary device connected to the device (node). For example, the microphone may be a microphone of a set of earphones wirelessly connected to (e.g., paired with) the device. In some examples, any microphones associated with the device may be utilized, for example, a microphone integrated into the device in addition to a microphone of a secondary device such as an earphone. Permission for use of a microphone of a node may be granted once a node 112 has opted to join the sound collection session. If permission is not granted, the node may be kicked out of the mesh network (e.g., based on a preset policy). In some examples, each node may isolate different potential target sound sources, and then compare each target sound source to the audio signature in order to determine which sound source is the target sound source 110. Each node 112 may then locally assess the quality of audio of the target sound source 110. The assessments may be sent from the nodes 112 to the host node 112a, where the host node 112a may then determine which of the nodes 112 is currently generating the optimal audio output of the target sound source 110. For example, each node 112 may broadcast a tuple comprising the device ID of the node 112 and an indicator of audio quality (e.g., deviceID, audioQuality). The host node may collect the tuples from the nodes and formulate a list of device IDs along with the audio quality of the devices, where by ranking the received qualities, it may be determined which node has the highest quality audio.

Alternatively, each node 112 may send to the host node 112a captured audio, where the host node may then perform an assessment of quality for the captured audio of each node 112, and determine which of the nodes is currently generating the optimal audio output. In some examples, each node may send the audio captured at a respective node to the server 104, or may send the assessed quality of audio to the server 104, where the server may then either assess the quality of the received audio to determine which node is generating the optimal audio, or may determine which node is generating the optimal audio on the basis of the received assessments of quality. For example, the host node may generate the list of tuples as described above, then sort the list of tuples according to the audio quality, where the node with the best audio quality may be selected to upstream its audio to other nodes of the network.

In some examples, the optimal audio output of the target sound source may be determined based on a quality of the audio output of a plurality of nodes. For example, the quality of the audio output may be based on a MOS (mean opinion score) or a MDAQS (multi-dimensional audio quality score), which may be computed for the audio output of each of the plurality of nodes 112. These computed scores may be compared to a threshold (e.g., MOS>3), or historical scores for a particular target sound source 110, to determine the quality of the audio output. In some examples, a trained machine learning model may be utilized to output a score of quality, for example, for particular types of sound sources.

In some examples, as the nodes 112 may be spatially distributed (and their location may not be known), there may be a delay between different nodes capturing audio of the target sound source. Once audio output is received from the nodes, audio frames of the audio output may be compared to the audio signature to establish if the captured audio corresponds to the target sound source. In order to adjust for latency, a sliding window may be defined for the audio frames. Audio output from different nodes within the same and adjacent windows may be compared in order to determine which member has the cleanest and highest quality audio output that corresponds to the audio signature, for example, in terms of data match percentage. If or when a node is determined to have better audio form than the host node, then that node may be assigned as the new host node, and/or or only that node may be permitted to send upstream audio data collected from its microphone.

In some examples, it may be determined which node of the plurality of nodes is currently able to generate an optimal output based on a determination of which node has a microphone closest to the target sound source, and/or which node has the best audio capture of the target sound source. This will be explained further below.

In some examples, a node determined to be the node currently able to generate an optimal output (e.g., the optimal node) may be designated as the host node.

At 306, control circuitry, e.g., control circuitry of a node 112 or control circuitry of the server 104, provides an audio signal generated by a first node 112e determined to have the current optimal audio output to other nodes associated with the sound collection session. The first node 112e may, for example, transmit the audio signal to the server 104 or the host node 112a, which may then in turn distribute the audio signal to other nodes 112 associated with the sound collection session. In some examples, the first node 112e may itself distribute the audio signal to other nodes 112 associated with the sound collection session, where, for example, the first node 112a may distribute the audio signal to at least one other node, where the nodes may distribute the audio signal between themselves.

The nodes 112 associated with the sound collection session may then output audio corresponding to the audio signal, or cause audio corresponding to the audio signal to be output (e.g., via a speaker or through the speaker of a device connected to the node, such as a paired device). In some examples, the node itself may output the audio. In other examples, a device connected to the node, such as a set of earphones, may output the audio.

In some examples, once an optimal node is identified, nodes associated with the sound collection session might send a pairing request to the optimal node to receive the audio directly from the optimal node locally. The Bluetooth address of the host node may be taken from the Bluetooth mesh network.

In some examples, the Bluetooth multi-point connection may be leveraged if or when needed, for example, there is a change in which node is considered to be the optimal node as the target sound source moves. In some examples, rather than switching nodes, time synchronized audio samples from other nodes associated with the sound collection session may be overlaid, and the aggregated audio stream may be distributed from the cloud server to the members.

In some examples, the determination of which node of a plurality of nodes associated with the sound collection session is currently able to generate an optimal audio output corresponding to the target sound source (e.g., an optimal node) may be made dynamically. For example, the audio output of nodes 112 may be continually or periodically assessed in order that the node providing the audio signal is the node which is currently able to generate the optimal audio output. In some examples, it may be determined whether the quality of the audio signal generated by the first node has fallen below a predefined threshold. Similarly to the threshold described above, to determine the quality of audio output of nodes, the threshold may be based on a metric such as a MOS or MDAQS, where it may be determined whether the quality of the audio signal of the first node has fallen below the predefined threshold (e.g., where the threshold may be set to e.g., MOS>3).

Where it is determined that the quality of the audio signal has fallen below the predefined threshold, the node currently able to generate the optimal audio output of the target sound source 110 may be redetermined. For example, the processes described above, such as the assessment of the quality of audio output of the nodes, may be performed in order to establish which node of the plurality of nodes is currently able to generate the optimal audio output. In some examples, if the quality of audio output of all the nodes is below the threshold, the quality of audio output of the nodes may be ranked to determine which of the nodes is able to produce the optimal audio output, even if this is below the threshold. If a second node has been determined to have the current optimal audio output (e.g., a node different to the node currently providing the audio signal), the first node 112e may cease providing the audio signal, and the second node may instead provide, or share, an audio signal as described above, where the audio signal is distributed to nodes 112 connected to the network, or associated with the sound collection session. In some examples, the optimal node may be determined in response to receiving a user request. For example, a user may determine that the quality of an audio signal which their device is receiving is of poor quality, and may request a reassessment of the nodes to determine if there is a node which is able to provide a better audio signal. In some examples, it may be determined which node is closest to the target sound source, and this node may be selected as the optimal node. Where the nodes and/or the target sound source 110 moves, a reassessment of which node is the optimal node may be made. This example will be described in more detail below.

In some examples it may be beneficial to assess nodes proximate to the first node to determine whether the first node is still providing the optimal audio output, in particular, this may be beneficial when the target sound source is moving, and/or when the location of the target sound source is not known, and/or the geometry of the network is not known, while reducing the processing burden.

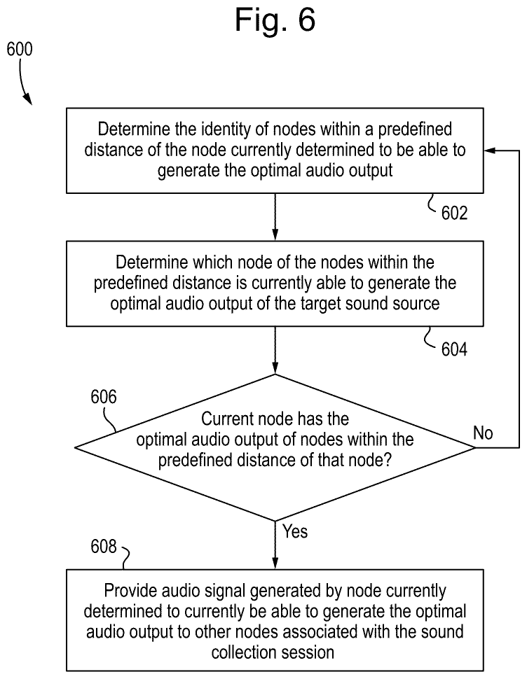

FIG. 6 shows a flowchart representing an illustrative process 600 for dynamically determining which node is currently able to generate an optimal audio output corresponding to the target sound source. While the example shown in FIG. 6 refers to the use of system 100, as shown in FIG. 1, it will be appreciated that the illustrative process shown in FIG. 6 may be implemented, in whole or in part, on system 100 and system 200, either alone or in combination with each other, and/or any other appropriately configured system architecture.

At 602, control circuitry, e.g., control circuitry of a node 112 or control circuitry of the server 104, determines the identity of nodes within a predefined distance of the node currently determined to be able to generate the optimal audio output. For example, the identity of nodes with a particular radius of the current node may be determined. Where no nodes exist within a predefined distance, the distance may be increased (e.g., incrementally), until at least one node is present within the predefined distance of the current nodes.

At 604, control circuitry, e.g., control circuitry of a node 112 or control circuitry of the server 104, determines which node of the nodes within the predefined distance is currently able to generate the optimal audio output of the target sound source. For example, the quality of the sound output of each node within the predefined distance may be assessed as described above to determine which of the nodes is currently generating the optimal audio output.

At 606, control circuitry, e.g., control circuitry of a node 112 or control circuitry of the server 104, determines whether the node currently determined to be able to generate the optimal audio output has the optimal audio output of nodes within the predefined distance of that node. For example, it may be determined whether the currently determined optimal node (e.g., the node currently providing the audio signal) is still able to provide the optimal audio output, or whether there is another node proximate to the current optimal node which is instead providing the optimal audio output.

When it is determined that the node currently determined to be able to generate the optimal audio output has the optimal audio output of nodes within the predefined distance of that node (YES at 606), control circuitry, e.g., control circuitry of a node 112 or control circuitry of the server 104, provides an audio signal generated by the node determined to currently be able to generate the optimal audio output to other nodes associated with the sound collection session. For example, where the node currently providing the audio signal is determined to have the optimal audio output of the nodes within the predefined distance, it may be assumed that that node has the optimal audio output of all nodes connected to the network. This node may therefore continue to provide the audio signal.

Where it is determined that the node currently determined to be able to generate the optimal audio output does not have the optimal audio output of nodes within the predefined distance of that node (NO at 606), the process moves back to 602. For example, where a second node is able to generate the optimal audio output, the second node may be set as the node currently able to generate the optimal audio output. Then, the steps of 602 (e.g., identifying nodes within a predefined distance of the second node), 604 (determining which node within the predefined distance of the second node is currently able to generate the optimal audio output), and 606 (determining which of the nodes within the predefined distance of the second node has the optimal audio output) are performed.

When it is determined that the second node is providing the optimal audio output (e.g. at 608), the second node may provide an audio signal to other nodes associated with the sound collection. Where it is determined that another node, e.g., a third node, is providing the optimal audio output, the third node may be set as the node currently able to generate the optimal audio output, and the steps may once again be repeated.

By performing an iterative process such as the one described above (which may be described as a graph search algorithm), it is possible to establish the optimal node for generating an audio signal of the target sound source without requiring knowledge of the exact geometry of the network or the location of the speaker, and without requiring the processing of the audio output of all nodes of the network.

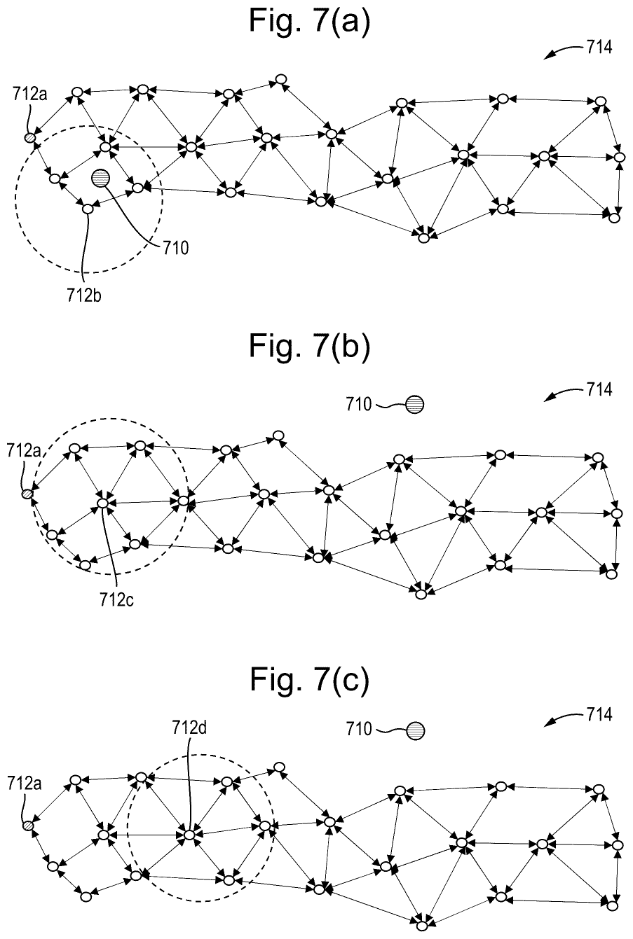

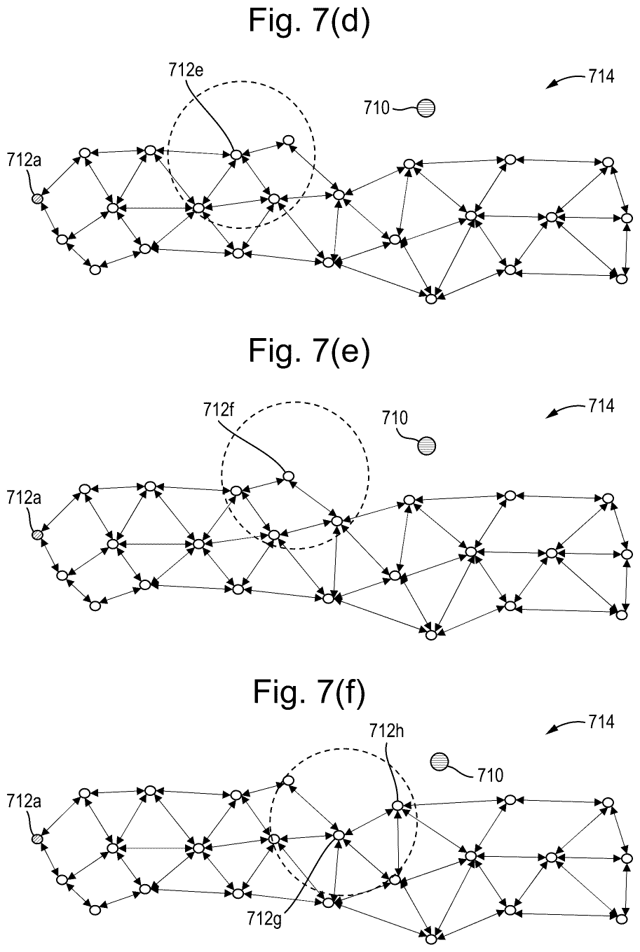

FIG. 7a-f illustrates an example of a system 700 for determining a node currently able to generate an optimal audio output of a target sound source 710. In particular, FIG. 7 illustrates a system configured to perform the iterative process of FIG. 6.

FIG. 7a-f illustrates a plurality of nodes 712 forming a network 714 (e.g., a mesh network) (the nodes illustrated in FIG. 7 are labelled 712a-712h, the reference numeral 712 is used here to refer to any of nodes 712a-712h, or any other node of the network 714) One node is designated as the host node 712a, which initiates the sound collection session. As is further illustrated here, a node which is currently providing the audio signal is shown (e.g., a node currently determined to be producing the optimal audio signal), and the target sound source is also shown. It may be assumed that the processes outlined above to establish a node that is currently able to generate an optimal audio output corresponding to the target sound source have been performed, and an audio signal is currently being provided by a first node 712b.

In this example, the target sound source 710 is moving. As is shown in FIG. 7a, initially, the first node 712b is closest to the target sound source when the target sound source 710 is in a first position as shown in FIG. 7a, and the first node 712b currently generates the optimal audio output. However, as is also shown in this example, the target sound source 710 moves to a second position away from the first node 712b, shown in FIG. 7b-f. It is assumed that the location of the target sound source 710 is not known to the nodes of the network. The following process is therefore used to establish which node of the mesh network is able to produce the optimal audio output when the target sound source 710 is at the second position.

The system may configure a pre-specified threshold on the audio quality as is described above. While the quality of the audio signal is within the threshold, the currently selected node may continue to stream the audio signal. If the audio quality drops below the threshold (e.g., a likely occurrence when the target sound source 710 has moved away from the node), the system may determine a need to reassess which of the nodes is to provide the audio signal. In some examples, the quality of the audio signal may be determined using a standardized algorithm, such as the perceptual evaluation of audio quality (PEAQ) algorithm.

In some examples, as is described above, to establish which node is able to produce the optimal audio output, a request may be sent to each node of the network to turn on their microphones and evaluate the current quality of their audio output. In this example, rather than requiring reassessment of all nodes, the system may search for the most likely candidates for an optimal audio output according to their distance from the currently selected node. As a Bluetooth Mesh utilizes Bluetooth Low Energy standard, the currently selected node will maintain a sorted list of other nodes according to their distance from the currently selected node. An assessment of which node may be currently producing the optimal audio output may thus be determined by starting with a group of nodes that are closest to the current node (e.g., within a certain radius of the current node). A broadcast message may be sent to command the nodes determined to be within a predefined distance (illustrated here as a dotted circle) of the current node to turn on their microphones and evaluate the quality of the audio output generated (e.g., using the target audio signature). The predefined distance may be set at a small value, such as 5 meters. If no node within this radius has better audio quality than the currently selected node, or there are no or few nodes within this radius, the radius may be increased accordingly.

As can be seen in FIG. 7a, the predefined distance surrounding the first node 712b encompasses three additional nodes. An assessment of these nodes is made to determine which of these nodes is able to provide the optimal audio output. In this example, it is determined that a second node 712c is able to provide the optimal audio output.

Once a node has been found with a better audio quality than the node currently determined to have the optimal audio output, the assessment may be re-performed with the new node as the center of the radius, and the search for the optimal node may continue. This is illustrated in FIG. 7b, where the second node 712c becomes the center of the radius. If the audio quality of the audio output of the new node is higher than the threshold, a switch may occur so that the new node may provide the audio signal rather than the previous node while the search for the optimal node continues. By repeating the process, the search may converge on an optimal node. Once the search is complete, and the optimal node has been found, that node may be used to provide an audio signal which is distributed to other nodes of the network. For example, by re-performing the process for the second node 712c, it is determined that a third node 712d is the current optimal node (shown in FIG. 7c). Then, by reperforming the process for the third node 712d, it is determined that a fourth node 712e is the current optimal node (shown in FIG. 7d). Then, by reperforming the process for the fourth node 712e, it is determined that a fifth node 712f is the current optimal node (shown in FIG. 7e). Then, by reperforming the process for the fifth node 712f, it is determined that a sixth node 712g is the current optimal node (shown in FIG. 7f). Then, by reperforming the process for the sixth node 712g, it is determined that a seventh node 712h is the current optimal node. When the process is repeated for the seventh node 712h (not shown here), it is determined that the seventh node 712h is the optimal node, and therefore this node is used to provide an audio signal of the target sound source 710.

In some examples, in order to accelerate the search for the optimal node, smaller subsets of the mesh network may be utilized, for example, where the number of devices is high, by having each subset of nodes determine which node of the subset has the optimal audio output. Each subset may then report the node having the best audio quality of that subset to the host node, and the host node may determine which of these nodes has the optimal audio output and should be used to provide an audio signal.

In some examples, a node may opt to not be considered or provide the audio signal, for example, where the battery of the node is low, when data usage is reaching its quota, where the node does not have access to a microphone, and so on.

The process outlined above may be running recursively in order to provide the optimal audio signal, until the sound collection session is terminated. The sound collection session may be terminated if a host terminates the session, there is no good audio match for the target sound source (e.g., based on audio of any node of the network), and so on. For example, where no good audio signature match is detected, the audio stream may stall, where after a grace period, a group terminate message may be sent, e.g., from the cloud server 104, to the host node if no apparent improvement is detected, or the host node may determine that the session should be terminated.

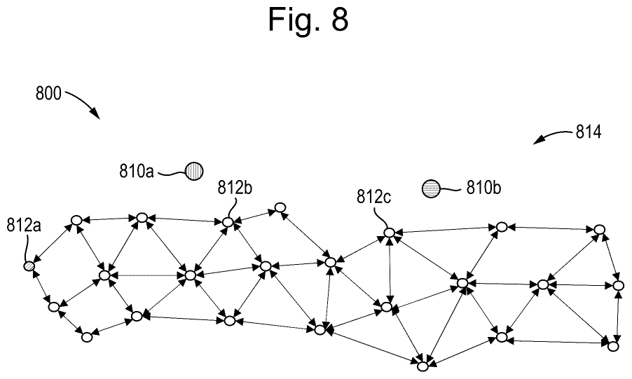

FIG. 8 illustrates an example of a system 800 for determining the nodes currently able to generate optimal audio outputs for a plurality of target sound sources 810a and 810b. In particular, FIG. 8 illustrates a plurality of nodes 812 forming a network 814, and a host node 812a (the nodes illustrated in FIG. 8 are labelled 812a-812c, the reference numeral 812 is used here to refer to any of nodes 812a-812c or any other nodes of the network 814).

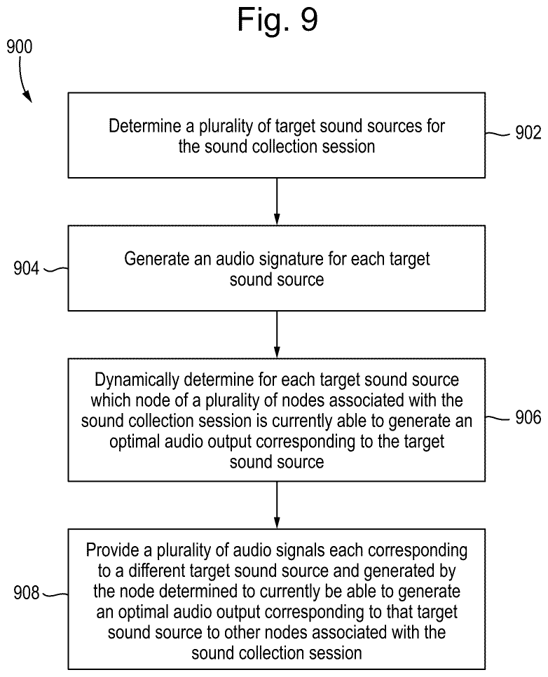

FIG. 9 shows a flowchart representing an illustrative process 900 for dynamically determining which nodes are currently able to generate an optimal audio output corresponding to a plurality of target sound sources. While the example shown in FIG. 9 refers to the use of system 800, as shown in FIG. 8, it will be appreciated that the illustrative process shown in FIG. 9 may be implemented, in whole or in part, on system 100 and system 200, either alone or in combination with each other, and/or any other appropriately configured system architecture.

At 902, control circuitry, e.g., control circuitry of a node 812 or control circuitry of the server 104, determines a plurality of target sound sources for the sound collection session. For example, the host node 812a may detect a first target sound source 810a and a second target sound source 810b. In an example, it may be determined whether the target sound source is generating speech. Where it is determined that the target sound source is generating speech, it may be further determined whether an interaction (e.g., a conversation) between more than one target sound source is occurring. This may be achieved by any appropriate process, such as by detecting the words spoken, where if another sound source is using a word expected in response to words spoken by the target sound source (e.g., based on a word list and detected by a large language model), it may be determined that a conversation, question and answer session, or joint presentation, is occurring. Thus, audio from more than one target sound source may be captured.

At 904, control circuitry, e.g., control circuitry of a node 812 or control circuitry of the server 104, generates an audio signature for each target sound source. For example, a first audio signature may be generated for the first target sound source 810a, and a second audio signature may be generated for the second target sound source 810b.

At 906, control circuitry, e.g., control circuitry of a node 812 or control circuitry of the server 104, dynamically determines for each target sound source which node of a plurality of nodes associated with the sound collection session is currently able to generate an optimal audio output corresponding to the target sound source. For example, for the first target sound source 810a, it may be determined that a first node 812b is the optimal node, and for the second target sound source 810b, it may be determined that a second node 812c is the optimal node.

At 908, control circuitry, e.g., control circuitry of a node 812 or control circuitry of the server 104, provides a plurality of audio signals each corresponding to a different target sound source and generated by the node determined to currently be able to generate an optimal audio output corresponding to that target sound source to other nodes associated with the sound collection session. For example, the audio signal corresponding to a target sound source comprises audio corresponding to the audio signature for that target sound source. For example, the first node 812b may provide an audio signal corresponding to the first target sound source 810a, and the second node 812c may provide an audio signal corresponding to the second target sound source 810b.

It will be appreciated that, in some examples, the same node may provide the optimal audio output for more than one target sound source, and therefore a node may provide more than one audio signal corresponding to each target sound source for which the node is determined to be the optimal node, or may provide one audio signal that comprises audio of each target sound source.

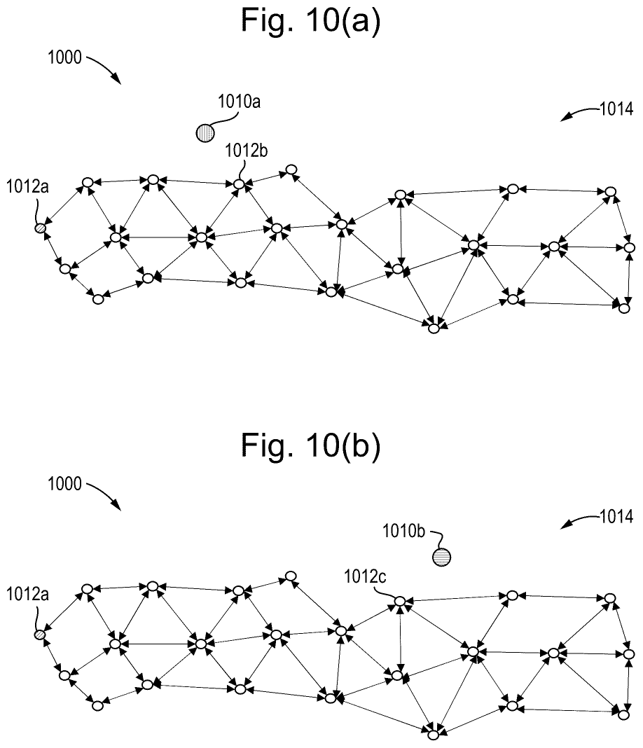

FIG. 10a-b illustrates an example of a system 1000 for determining the node currently able to generate an optimal audio output when a target sound source 1010 changes. In particular, FIG. 10a-b illustrates a plurality of nodes 1012 forming a network, and a host node 1012a (the nodes illustrated in FIG. 10 are labelled 1012a-1012c, the reference numeral 1012 is used here to refer to any of nodes 1012a-1012c or any other nodes of the network 1014). FIG. 10a illustrates a first target sound source 1010a, where a first node 1012b has been determined to be the optimal node for the first target sound source 1010a. FIG. 10b illustrates an example in which the target sound source is no longer the first target sound source 1010a, for example, as the first target sound source is no longer producing sound. A second target sound source 1010b is designated as the new target sound source, and a second node 1012c is determined to be the optimal node for the new target sound source.

In some examples, the host node 1012a may change the target sound source. The sound collection session may be paused while the new target sound source is selected. This change may be (and in some examples with a sample of audio of the new target sound source) indicated visually to participants of the sound collection session. An audio signature of the new target sound source may be sent to nodes of the sound collection session. A node may then opt to leave the sound collection session where there is no interest in the new target sound source. In some examples, a default setting may be to remove nodes participating in the sound collection session if the target sound source changes. Nodes may then opt to join a new sound collection session which is initiated in respect of the new target sound source.

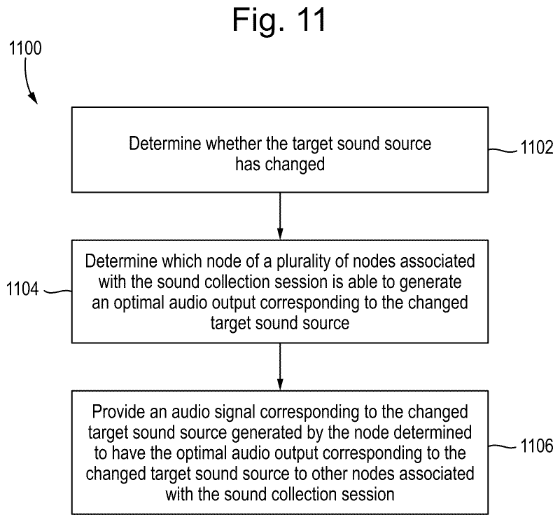

FIG. 11 shows a flowchart representing an illustrative process 1100 for dynamically determining which node is able to generate an optimal audio output when a target sound source changes. While the example shown in FIG. 11 refers to the use of system 1100, as shown in FIG. 10, it will be appreciated that the illustrative process shown in FIG. 11 may be implemented, in whole or in part, on system 100 and system 200, either alone or in combination with each other, and/or any other appropriately configured system architecture.

At 1102, control circuitry, e.g., control circuitry of a node 1012 or control circuitry of the server 104, determines whether the target sound source has changed. This may be determined based on, for example, an indication made by the host node 1012a that the target sound source is to change, a detection of a reduction or absence in sound from a current target sound source and an increase in sound from a different sound source, a detection of a conversation between persons, and so on.

At 1104, control circuitry, e.g., control circuitry of a node 1012 or control circuitry of the server 104, determines which node of a plurality of nodes associated with the sound collection session is able to generate an optimal audio output corresponding to the changed target sound source. For example, where the second target sound source 1010b is the new target sound source, the second node 1012c is determined to be the optimal node.

At 1106, control circuitry, e.g., control circuitry of a node 1012 or control circuitry of the server 104, provides an audio signal corresponding to the changed target sound source generated by the node determined to have the optimal audio output corresponding to the changed target sound source to other nodes associated with the sound collection session. For example, the second node 1012c may provide the audio signal for the second target sound source 1010b.

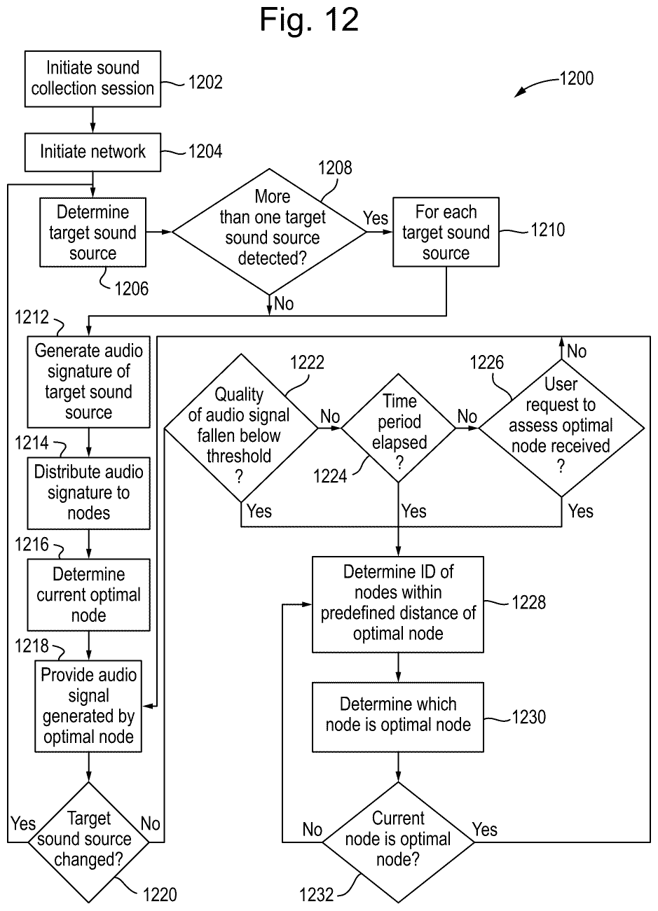

FIG. 12 shows a flowchart representing an illustrative process 1200 for determining which node to utilize to provide an audio signal corresponding to a target sound source. It will be appreciated that the illustrative process shown in FIG. 12 may be implemented, in whole or in part, on system 100 and system 200, either alone or in combination with each other, and/or any other appropriately configured system architecture.

At 1202, control circuitry, e.g., control circuitry of a node 112 or control circuitry of the server 104, initiates a sound collection session. For example, a sound collection session may be initiated by a user at a host node (e.g., a user device).

At 1204, control circuitry, e.g., control circuitry of a node 112 or control circuitry of the server 104, initiates a network. For example, a mesh network, such as a Bluetooth mesh network may be initiated.

At 1206, control circuitry, e.g., control circuitry of a node 112 or control circuitry of the server 104, determines a target sound source. For example, the host node may determine a target sound source.

At 1208, control circuitry, e.g., control circuitry of a node 112 or control circuitry of the server 104 determines whether more than one target sound source has been detected. For example, in determining the target sound source, more than one potential target sound source may be detected.

Where more than one target sound source is detected (YES at 1208), at 1210, control circuitry, e.g., control circuitry of a node 112 or control circuitry of the server 104, causes the subsequent method from 1212 to be performed for each target sound source. For example, the process may be performed in parallel for each target sound source, where different optimal nodes may be detected in respect of each target sound source.

Where more than one target sound source is not detected (NO at 1208), the process moves to 1212. At 1212, control circuitry, e.g., control circuitry of a node 112 or control circuitry of the server 104, generates an audio signature of the target sound source.

At 1214, control circuitry, e.g., control circuitry of a node 112 or control circuitry of the server 104 distributes the audio signature to nodes of the network (e.g., nodes associated with the sound collection session).

At 1216, control circuitry, e.g., control circuitry of a node 112 or control circuitry of the server 104 determines the current optimal node. For example, the current optimal node may be the node determined to be closest to the target sound source, and/or may be the node determined to be outputting the highest quality audio of the target sound source.

At 1218, control circuitry, e.g., control circuitry of a node 112 or control circuitry of the server 104 provides an audio signal generated by the optimal node to other nodes associated with the sound collection session.

At 1220, control circuitry, e.g., control circuitry of a node 112 or control circuitry of the server 104 determines whether the target sound source has changed. For example, it may be periodically determined whether the target sound source has changed.

Where it is determined that the target sound source has changed (YES at 1220), the process moves back to 1206.

Where it is determined that the target sound source has not changed (NO at 1220), at 1222, control circuitry, e.g., control circuitry of a node 112 or control circuitry of the server 104 determines whether the quality of the audio signal has fallen below a threshold.

Where it is determined that the quality of the audio signal has fallen below a threshold (YES at 1222), at 1228, control circuitry, e.g., control circuitry of a node 112 or control circuitry of the server 104, determines the identity (ID) of nodes within a predefined distance of the optimal node.

Where it is determined that the quality of the audio signal has not fallen below a threshold (NO at 1222), at 1224, control circuitry, e.g., control circuitry of a node 112 or control circuitry of the server 104 determines whether a predetermined time period has elapsed (e.g., a periodic check is made).

Where it is determined that a predetermined time period has elapsed (YES at 1224), the process moves to 1228.

Where it is determined that a predetermined time period has not elapsed (NO at 1224), at 1226, control circuitry, e.g., control circuitry of a node 112 or control circuitry of the server 104 determines whether a user request to assess the optimal node has been received.

Where it is determined that a user request has not been received (NO at 1226), the process moves back to 1218.

Where it is determined that a user request has been received (YES at 1226), the process moves to 1228.

At 1230, control circuitry, e.g., control circuitry of a node 112 or control circuitry of the server 104 determines which node of the nodes bounded by the predefined distance of the optimal node (including the optimal node) is the optimal node (e.g., determine which of these nodes is generating the optimal audio output).

At 1232, control circuitry, e.g., control circuitry of a node 112 or control circuitry of the server 104 determines whether the current node (e.g., the node currently providing the audio signal, or the node currently determined to be producing the optimal audio output) is the optimal node, or whether another node is instead generating the optimal audio output.

Where the node currently determined to be providing the optimal audio output is not the currently determined optimal node (NO at 1232), the process moves to step 1228.

Where the node currently determined to be providing the optimal audio output is the current node (YES at 1232), the process moves to 1218.

The actions or descriptions of FIG. 12 may be done in any suitable alternative orders or in parallel to further the purposes of this disclosure.

In some examples, an optimal node may be selected using localization techniques, such as beamforming processes. For example, the direction of arrival and/or the time of arrival parameters may be calculated from received beams of the sound source to determine the optimal node at a given time (e.g., the node of the mesh network closest to the target sound source may be computed based on a predicted location of the target sound source, using localization techniques, and/or based on the direction of arrival and time of arrival of audio signals received from the different nodes of the mesh network).

In some examples, nodes of the sound collection session may pair an audio output device (e.g., a set of earphones paired to the node, or the node itself) with the optimal node providing the audio signal. To do so, the audio output devices may advertise their Bluetooth address, and the optimal node may scan for such devices. The optimal node may initiate a connection to the audio output devices and supply the audio signal via these connections. Where the mesh network comprises many devices wishing to pair with the optimal node, the mesh may be divided into subgroups, where the node of a subgroup that is determined to be the optimal node may provide an audio signal to audio output devices of nodes of the subgroup via a direct Bluetooth connection. In some examples, audio output devices may utilize the mesh network to determine the address of the host node and send a message to the host node to initiate a pairing process with the host node. In this way, the steps of advertising an address and scanning for devices may be avoided. When a host device changes, the connections between the host node and audio output devices may end.

In some examples, users of nodes which may potentially join the mesh network may be members of a social network (e.g., Instagram, TikTok, LinkedIn) or group using a messaging service (e.g., such as iMessage or Discord). For example, the social network or group may relate to the current target sound source, such as a concert involving the target sound source, a lecture, and so on. Information regarding a sound collection session, for example, sample audio and icon metatags, may be relayed to the messaging system. This may accelerate formation of a sound collection session. For example, the host node may send information regarding a sound collection session to a messaging service. The messaging service may then distribute this information to users associated with the messaging service, where the users may then opt to join the sound collection session.

In some examples, the sound collection session may be established to monitor for a particular sound or type of sound, for example, an announcement made over a speaker system, an alarm, or an alert. In some examples, the sound may be a sound which may indicate an emergency situation, or that an action should be taken, such as glass breaking, a baby crying, or a scream. In some examples, the sound may be a sound associated with the operation of a device such as machinery (e.g., a sound above a certain decibel range or indicating a malfunction) and so on. In some examples, the sound may have a sound signature associated with a particular operation of a device. The methods above may be used to establish an audio signature of the type of sound, where a plurality of nodes connected by a mesh network perform a listening function. Once the sound occurs, it may be determined which node is currently able to generate an optimal audio output corresponding to the sound, and that node may provide an audio signal corresponding to that sound to other nodes of the network. Alternatively or additionally, a node which “hears” the sound may provide an indication that the particular sound has been heard to other nodes of the network, e.g., to initiate the assessment of which node is able to provide the optimal audio output, or to notify other nodes of the network that the sound has occurred.

In some examples, the location of a microphone of a node associated with the sound collection session may be determined with respect to the target sound source by analyzing the received beam direction of arrival of a signal, where a map of the spatial positioning of the microphones over time may then be determined. The map may be updated as the target sound source moves, and if or when the location of the microphone of a node moves. It may be determined that a microphone of a node has moved based on data generated by a sensor of the node, such as an inertial measurement sensor. In this case, the optimal node may be determined to be the node closest to the target sound source at any given time.

In some examples, where nodes determine that they are in the same venue, based on simultaneous localization and mapping (SLAM) data that has been captured or has been provided, an approximate delay from the sound source may be computed, and the latency parameters between the nodes may be adjusted and normalized to perform an audio signature comparison to determine the optimal node. A decision as to which node will act as the host node, and the selection of an optimal node for a target sound source, may also be based on the location of the target sound source within the SLAM map, and location of other nodes within the SLAM map, where the node closest to the target sound source may be selected as the optimal node. In some examples, a node may apply a node-specific audio post processing procedure to a received audio signal.

The processes described above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one example may be applied to any other example herein, and flowcharts or examples relating to one example may be combined with any other example in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
initiating, using control circuitry, a sound collection session for a plurality of nodes;
determining, using control circuitry, a target sound source for the sound collection session;
dynamically determining, using control circuitry, which node of a plurality of nodes associated with the sound collection session is currently able to generate an optimal audio output corresponding to the target sound source; and
providing, using control circuitry, an audio signal generated by a first node determined to have the current optimal audio output to other nodes associated with the sound collection session.

2. The method of claim 1, wherein the method further comprises:
determining whether the quality of the audio signal has fallen below a predefined threshold;
redetermining which node is currently able to generate the optimal audio output of the target sound source when the quality of the provided audio signal falls below the predefined threshold; and
providing an audio signal generated by a second node determined to have the current optimal audio output to other nodes associated with the sound collection session.

3. The method of claim 2, wherein the redetermining further comprises
i) determining the identity of nodes within a predefined distance of the node currently determined to be able to generate the optimal audio output;
ii) determining which node of the nodes within the predefined distance is currently able to generate the optimal audio output of the target sound source; and
repeating steps i) and ii) until the node currently determined to currently be able to generate the optimal audio output has the optimal audio output of nodes within the predefined distance of that node.

4. The method of claim 1, wherein the method further comprises generating an audio signature of the target sound source, and distributing the audio signature to nodes associated with the sound collection session.

5. The method of claim 1, wherein the method further comprises initiating a mesh network for the plurality of nodes.

6. The method of claim 1, wherein dynamically determining which node of a plurality of nodes associated with the sound collection session is currently able to generate an optimal audio output of the target sound source comprises at least one of:
periodically assessing which node of the plurality of nodes associated with the sound collection session is currently able to generate the optimal audio output of the target sound source;
determining which of the plurality of nodes associated with the sound collection session is currently able to generate an optimal audio output of the target sound source responsive to receiving a user request;
dynamically determining which node of the plurality of nodes associated with the sound collection session is currently closest to the target sound source; and
determining the node closest to the target sound source as being currently able to generate an optimal audio output of the target sound source.

7. The method of claim 1, wherein the method further comprises:
determining a plurality of target sound sources for the sound collection session;
generating an audio signature for each target sound source;
dynamically determining for each target sound source which node of the plurality of nodes associated with the sound collection session is currently able to generate an optimal audio output corresponding to that target sound source based on the audio signature; and
providing a plurality of audio signals each corresponding to a different target sound source and generated by the node determined to currently be able to generate an optimal audio output corresponding to that target sound source to other nodes associated with the sound collection session, wherein the audio signal corresponding to a target sound source comprises audio corresponding to the audio signature for that target sound source.

8. The method of claim 1, wherein the optimal audio output of the target sound source is determined based on at least one of: a quality of the audio output of a plurality of nodes; or a distance of each node of the plurality of nodes associated with the sound collection session from the target sound source.

9. The method of claim 1, wherein the audio output of the target sound source generated by a node is assessed at the node at which it is generated, and wherein the determination is made based on an indication of the assessment received from the node.

10. The method of claim 1, wherein the method further comprises:
determining whether the target sound source has changed;
in response to determining that the target sound source has changed, determining which node of a plurality of nodes associated with the sound collection session is able to generate an optimal audio output corresponding to the changed target sound source; and
providing an audio signal corresponding to the changed target sound source generated by the node determined to have the optimal audio output corresponding to the changed target sound source to other nodes associated with the sound collection session.

11. A system comprising control circuitry configured to:
initiate a sound collection session for a plurality of nodes;
determine a target sound source for the sound collection session;
dynamically determine which node of a plurality of nodes associated with the sound collection session is currently able to generate an optimal audio output corresponding to the target sound source; and
provide an audio signal generated by a first node determined to have the current optimal audio output to other nodes associated with the sound collection session.

12. The system of claim 11, wherein the control circuitry is further configured to:
determine whether the quality of the audio signal has fallen below a predefined threshold;
redetermine which node is currently able to generate the optimal audio output of the target sound source when the quality of the provided audio signal falls below the predefined threshold; and
provide an audio signal generated by a second node determined to have the current optimal audio output to other nodes associated with the sound collection session.

13. The system of claim 12, wherein the redetermining further comprises:
i) determining the identity of nodes within a predefined distance of the node currently determined to be able to generate the optimal audio output;
ii) determining which node of the nodes within the predefined distance is currently able to generate the optimal audio output of the target sound source; and
repeating steps i) and ii) until the node currently determined to currently be able to generate the optimal audio output has the optimal audio output of nodes within the predefined distance of that node.

14. The system of claim 11, wherein the control circuitry is further configured to generate an audio signature of the target sound source, and distribute the audio signature to nodes associated with the sound collection session.

15. The system of claim 11, wherein the control circuitry is further configured to initiate a mesh network for the plurality of nodes.

16. The system of claim 11, wherein dynamically determining which node of a plurality of nodes associated with the sound collection session is currently able to generate an optimal audio output of the target sound source comprises at least one of:
periodically assessing which node of the plurality of nodes associated with the sound collection session is currently able to generate the optimal audio output of the target sound source;
determining which of the plurality of nodes associated with the sound collection session is currently able to generate an optimal audio output of the target sound source responsive to receiving a user request;
dynamically determining which node of the plurality of nodes associated with the sound collection session is currently closest to the target sound source; and
determining the node closest to the target sound source as being currently able to generate an optimal audio output of the target sound source.

17. The system of claim 11, wherein the control circuitry is further configured to:
determine a plurality of target sound sources for the sound collection session;
generate an audio signature for each target sound source;
dynamically determine for each target sound source which node of the plurality of nodes associated with the sound collection session is currently able to generate an optimal audio output corresponding to that target sound source based on the audio signature; and
provide a plurality of audio signals each corresponding to a different target sound source and generated by the node determined to currently be able to generate an optimal audio output corresponding to that target sound source to other nodes associated with the sound collection session, wherein the audio signal corresponding to a target sound source comprises audio corresponding to the audio signature for that target sound source.

18. The system of claim 11, wherein the optimal audio output of the target sound source is determined based on at least one of: a quality of the audio output of a plurality of nodes; or a distance of each node of the plurality of nodes associated with the sound collection session from the target sound source.

19. The system of claim 11, wherein the audio output of the target sound source generated by a node is assessed at the node at which it is generated, and wherein the determination is made based on an indication of the assessment received from the node.

20. The system of claim 11, wherein the control circuitry is further configured to:
determine whether the target sound source has changed;
in response to determining that the target sound source has changed, determine which node of a plurality of nodes associated with the sound collection session is able to generate an optimal audio output corresponding to the changed target sound source; and
provide an audio signal corresponding to the changed target sound source generated by the node determined to have the optimal audio output corresponding to the changed target sound source to other nodes associated with the sound collection session.

21-50. (canceled)
